(19) United States
(12) Patent Application Publication
(10) Pub. No.: US 2006/0091814 A1
(43) Pub. Date: May 4, 2006

(54) Light-emitting display device

(75) Inventor: Masao Katou, Suita-shi (JP)

Correspondence Address: HAMRE, SCHUMANN, MUELLER & LARSON, P.C., P.O. BOX 2902-0902, MINNEAPOLIS, MN, 55402, US

(73) Assignee: MATSUSHITA TOSHIBA PICTURE DISPLAY CO., LTD., Takatsuki-shi (JP)

(21) Appl. No.: 11/254,101

(22) Filed: Oct. 19, 2005

(30) Foreign Application Priority Data
Nov. 2, 2004 (JP) 2004-319438

(51) Int. Cl. G09G 3/10

(52) U.S. Cl. 315/169.1

(57) ABSTRACT

Based on an output signal from a light-emission characteristic correction portion, a data voltage supply portion supplies data voltage to pixels and a light-emission quantity detector detects light-emission quantities of each pixel. The light-emission characteristic correction portion includes a display signal processor for subjecting display signal data to a correction based on a light-emission characteristic held in a memory; a test signal supply portion for generating a test signal in order to apply a test voltage to each pixel; a mode control portion for outputting the output from the display signal processor or the test signal to the data voltage supply portion; and a light-emission characteristic detection portion for detecting the light-emission characteristic of each pixel based on the light-emission quantity detection value and the test signal. The mode control portion performs control so that, in display mode, the output from the display signal processor is supplied to the data voltage supply portion, in light-emission characteristic detection mode, the test signal is supplied to the data voltage supply portion, and output from the light-emission characteristic detection portion is supplied to the memory. Variations in the light-emission characteristic of each pixel can be detected and display unevenness on a screen can be effectively suppressed.

### BACKGROUND OF THE INVENTION

1. Field of the Invention

The present invention relates to light-emitting display devices, for example, inorganic EL (electroluminescent) display devices in which a display panel is composed of inorganic EL elements forming light-emitting elements arrayed as pixels, each pixel being driven selectively to display images.

2. Description of Related Art

An inorganic EL element has a structure in which a light-emitting layer that includes a phosphor layer and dielectric layers is sandwiched between a pair of electrodes, and emits light when a voltage pulse is applied between the pair of electrodes. A display panel in an inorganic EL display device is configured to have such inorganic EL elements arrayed in a matrix. That is, on a substrate, such as glass, a plurality of stripe electrodes are arranged in parallel with each other, for example in columns, to form data electrodes, and a plurality of stripe electrodes are arranged in parallel with each other and orthogonal to the data electrodes, to form scanning electrodes. A light-emitting layer is interposed between the data electrodes and the scanning electrodes, and at the intersection of the two sets of electrodes, an inorganic EL element is configured by a structure in which the light-emitting layer is sandwiched by the data electrodes and the scanning electrodes, to form a passive matrix display panel in which a plurality of display pixels is arrayed in two dimensions.

However, the EL element emits light by itself, which differs from liquid crystal, and due to variations in the characteristics of the light-emitting layer and changes over time, even if an identical driving voltage is applied, variations may occur in the quantity of light emitted from each pixel. In order to eliminate the display unevenness that consequently occurs in screens, International Patent Publication Number WO98/40871 describes a display device using a driving method that eliminates variations in the quantity of light emitted from each pixel. Specifically, when supplying a data signal of a predetermined voltage to a drive element, the current quantity flowing in the light-emitting element or the quantity of light emitted is detected, and the voltage of the data signal is adjusted so that the quantity comes close to a predetermined reference value.

However, International Patent Publication Number WO98/40871 does not clearly describe how to set the predetermined reference value when detecting a light-emitting element characteristic. The light-emitting element has variations in light-emission characteristics, as shown, for example, in FIG. 4 and FIG. 5. FIG. 4 shows variations in the threshold value characteristic, and FIG. 5 shows variations in the voltage-luminance characteristic gradient.

The light-emitting elements of two pixels, C1 and C2, shown in FIG. 4, provide an example of where the threshold values that are starting points for light emission differ from one another due to variations in light-emission layer characteristics or resistance values of ITO electrodes or the like. That is, the threshold value for the light-emitting element of pixel C1 is Vt1, and the threshold value for the light-emitting element of pixel C2 is Vt2. In these cases, even if an identical data voltage Vd is applied by voltage modulation or the like with an expectation that light of the same luminance will be emitted, different luminances It1 and It2 result.

Furthermore, the light-emitting elements of two pixels, C3 and C4, shown in FIG. 5, provide an example of the case where, even if the light emission start points (threshold values), Vt3 and Vt4, are the same, the voltage-luminance characteristic gradients for each pixel differ. In this case, even if an identical data voltage Vd is applied by voltage modulation or the like with an expectation that light of the same luminance will be emitted, different luminances It3 and 1t4 result. In particular, for input signals with gamma-correction, luminances with different gamma characteristics result.

The driving method described in International Patent Publication Number WO98/40871 did not give a practical detection method for the above type of variations in the light-emission characteristics.

### SUMMARY OF THE INVENTION

It is an object of the present invention to provide a light-emitting display device able to detect adequately variations in characteristics of light-emitting elements for each pixel and suppressing effectively display unevenness on a screen.

The light-emitting display device of the invention includes a display panel provided with a plurality of arrayed pixels having light-emitting elements, and a driving circuit for supplying data voltage corresponding to display signal data to each of the plurality of pixels.

The driving circuit includes: a light-emission characteristic correction portion that is supplied with the display signal data from an external source and outputs a signal obtained by subjecting the display signal data to a correction based on a light-emission characteristic of each of the pixels; a data voltage supply portion that supplies the data voltage for each of the pixels, based on signal output from the light-emission characteristic correction portion; and a light-emission quantity detector that outputs a light-emission quantity detection value corresponding to light-emission luminance of each of the pixels.

The light-emission characteristic correction portion includes: a light-emission characteristic memory holding the light-emission characteristic of each of the pixels; a display signal processor that subjects the display signal data to a correction based on the light-emission characteristic supplied from the light-emission characteristic memory and outputting the resultant display signal data; a test signal supply portion for generating a test signal with which a test voltage that increases from a predetermined low voltage is applied from the data voltage supply portion to each of the pixels; a mode control portion to which the test signal and the output signal from the display signal processor are input, and which selectively outputs one of the signals to the data voltage supply portion; a light-emission characteristic detection portion that detects the light-emission characteristic of each of the pixels based on the light-emission quantity detection value and the test signal; and a selector for supplying, according to control by the mode control portion, a detected output from the light-emission characteristic detection portion to the light-emission characteristic memory.

The mode control portion has a function of switching between display mode and light-emission characteristic detection mode, supplying output from the display signal processor to the data voltage supply portion when in the display mode, supplying the test signal to the data voltage supply portion when in the light-emission characteristic detection mode, and controlling the selector so as to supply detected output from the light-emission characteristic detection portion to the light-emission characteristic memory.

According to this configuration of the light-emitting display device, emitted light quantity of each pixel, based on the test signal supplied by the test signal supply portion, is detected, and based on this detected value and the test signal, the light-emission characteristic of each pixel is detected, so that variations in the characteristic of the light-emitting element of each pixel are detected adequately, and it is possible to suppress effectively the display unevenness on the screen.

### BRIEF DESCRIPTION OF THE DRAWINGS

FIG. 1 is a block diagram illustrating a schematic configuration of an inorganic EL display device according to an embodiment of the present invention.

FIG. 2 is a block diagram illustrating a configuration of a light-emission characteristic correction portion in a configuration of the same inorganic EL display device.

FIG. 3 is a diagram illustrating an example of an operation for detecting a threshold value and a voltage-luminance characteristic gradient (gamma characteristic) of the same inorganic EL display device.

FIG. 4 is a diagram illustrating an example of variations in a threshold value characteristic between pixels in a conventional light-emitting display device.

FIG. 5 is a diagram illustrating an example of variations in voltage-luminance characteristic gradient between pixels in a conventional light-emitting display device.

### DETAILED DESCRIPTION OF THE INVENTION

The light-emitting display device of the present invention having the above-described configuration can be configured so that the light-emission characteristic memory has a first memory for holding first light-emission characteristic data. The display signal processor has an offset adjustment portion that subjects the display signal data to a correction, based on the first light-emission characteristic data of each of the pixels supplied from the first memory, so as to adjust an offset value of the data voltage applied to each of the pixels. The light-emission characteristic detection portion outputs, as the first light-emission characteristic data, the test signal value for each of the pixels at which the output value of the light-emission quantity detector reaches, in the light-emission characteristic detection mode, a first reference value set to have a predetermined relationship with a threshold value of the light-emitting elements.

In this configuration, the light-emission characteristic memory further may include a second memory for holding second light-emission characteristic data. The display signal processor further may include a gamma characteristic adjustment portion that subjects the display signal data to a correction so as to adjust a gamma characteristic of each of the pixels, so that the display signal data is subjected to a composite adjustment by the gamma characteristic adjustment portion and the offset adjustment portion. The light-emission characteristic detection mode includes a first detection mode and a second detection mode in order to supply the test signal to the data voltage supply portion and to detect the light-emission characteristic. The light-emission characteristic detection portion, in the first detection mode outputs the first light-emission characteristic data, and in the second detection mode outputs, as the second light-emission characteristic data, the test signal value for each of the pixels at which the output value of the light-emission quantity detector reaches a second reference value. The selector, in the first detection mode, is controlled to supply the first light-emission characteristic data to the first memory, and in the second detection mode, to supply the second light-emission characteristic data to the second memory. The gamma characteristic adjustment portion subjects the display signal data to a correction based on the voltage-luminance characteristic of each of the pixels, the voltage-luminance characteristic being detected based on the first and the second light-emission characteristic data supplied by the first and the second memory, respectively.

In the light-emitting display device of this invention, the light-emission quantity detector may be composed of a current detector for detecting current flowing in each of the pixels as a result of the data voltage.

The light-emitting display device of this invention may be configured with an inorganic EL display panel, and may include a plurality of scanning electrodes; a plurality of data electrodes intersecting the scanning electrodes; an inorganic EL light-emission layer, including a dielectric layer and a phosphor layer, disposed between the scanning electrodes and the data electrodes; a scanning-side driving circuit for sequentially supplying scanning voltage to each of the scanning electrodes; a data-side driving circuit for supplying data voltage to each of the data electrodes, according to the display signal data; and a driving control circuit for controlling the scanning-side driving circuit and the data-side driving circuit according to an input signal from an external source. The pixels may be formed of the inorganic EL light-emission layer positioned at each intersection of the scanning electrodes and the data electrodes. The data-side driving circuit may include the light-emission characteristic correction portion and the data voltage supply portion. The display signal data may be supplied to the light-emission characteristic correction portion from the driving control circuit.

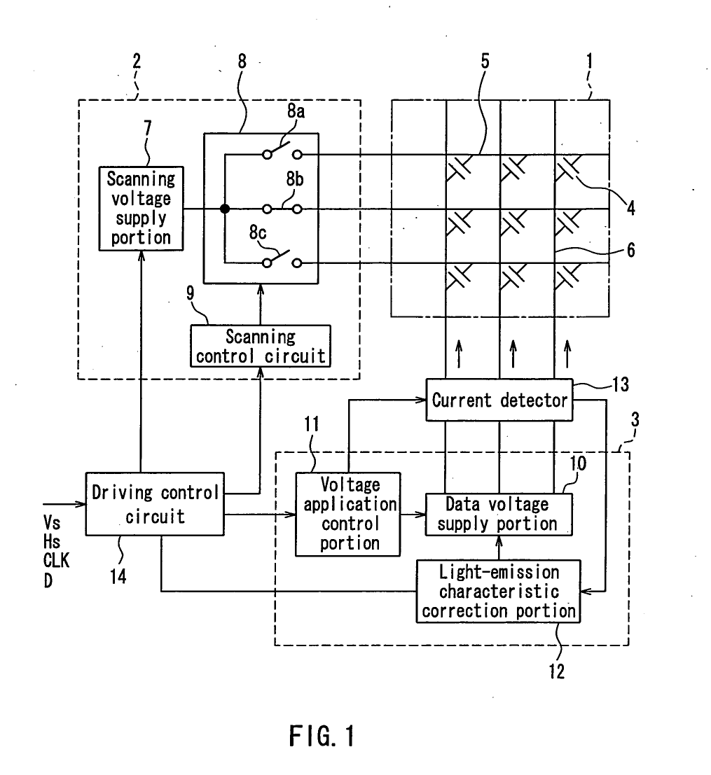

An embodiment of the light-emitting display device of the present invention is explained more specifically below, referring to the figures. In the embodiment below, an inorganic EL display device is explained as an example; however, configurations of the embodiment similarly can be applied to other light-emitting display devices. First, the basic structure of the inorganic EL display device according to the embodiment is explained, referring to FIG. 1.

FIG. 1 is a block diagram illustrating a schematic configuration of the inorganic EL display device according to the embodiment. This inorganic EL display device has an inorganic EL panel 1 forming a display area, a scanning-side driving circuit 2 and a data-side driving circuit 3, for driving the inorganic EL panel 1.

The inorganic EL panel 1 has a plurality of scanning electrodes 5 of linear shape and a plurality of data electrodes 6 intersecting the scanning electrodes 5 that are formed on an insulating substrate (not shown) with the inorganic EL light-emitting layer 4 sandwiched therebetween. The inorganic EL light-emitting layer 4 has a well known configuration, for example, formed of a phosphor layer and a dielectric film formed on at least one face thereof (though not shown). The intersection of each scanning electrode 5 and data electrode 6 forms each pixel, and a passive matrix display panel is formed on which a plurality of pixels are arrayed in two dimensions. However, the invention is not limited to passive matrix displays and also can be applied to other types of display panels.

The scanning-side driving circuit 2 sequentially applies a scanning voltage to each of the scanning electrodes 5. The scanning-side driving circuit 2 has a scanning voltage supply portion 7 for supplying the scanning voltage and a switch portion 8 for selectively supplying output from the scanning voltage supply portion 7 to each scanning electrode 5. In the switch portion 8, switches 8a-8c are controlled by a scanning control portion 9 and are turned ON sequentially; in this way scanning voltage is applied sequentially by the scanning voltage supply portion 7 to each of the scanning electrodes 5.

The data-side driving circuit 3 supplies, with timing controlled by a voltage application control portion 11, the data voltage generated by a data voltage supply portion 10, according to the display signal data, to each of the data electrodes 6. The data-side driving circuit 3 also has a light-emission characteristic correction portion 12, and the display signal data is input, via the light-emission characteristic correction portion 12, to a data voltage supply portion 10. The light-emission characteristic correction portion 12 implements a correction to the display signal data according to the light-emission characteristic of each pixel, and supplies the data to the data voltage supply portion 10. The data voltage supply portion 10 supplies the data voltage to each pixel based on a signal output from the light-emission characteristic correction portion 12. A current detector 13 is provided in order to detect current flowing based on the data voltage in each pixel of the inorganic EL panel 1. Since the detected current corresponds to the emitted light luminance of each pixel, the current detector 13 operates as a light-emission quantity detector to obtain the light-emission quantity detection value that represents the emitted light luminance of each pixel. In order to detect the emitted light luminance, a phase detector may be used instead of the current detector 13.

The scanning voltage supply portion 7, the scanning control portion 9, the voltage application control portion 11, and the light-emission characteristic correction portion 12 operate by a signal supplied by a driving control circuit 14. A vertical synchronizing signal Vs, a horizontal synchronizing signal Hs, a data transfer clock signal CLK, display signal data D and the like are input from an external source to the driving control circuit 14. Based on these signals, the driving control circuit 14 generates the respective necessary signals, and supplies these signals to the scanning-side driving circuit 2 and the data-side driving circuit 3. Since the scanning voltage supply portion 7, the scanning control portion 9, and the voltage application control portion 11 can be basically configured similarly to well known circuits, the specific explanation is not necessary.

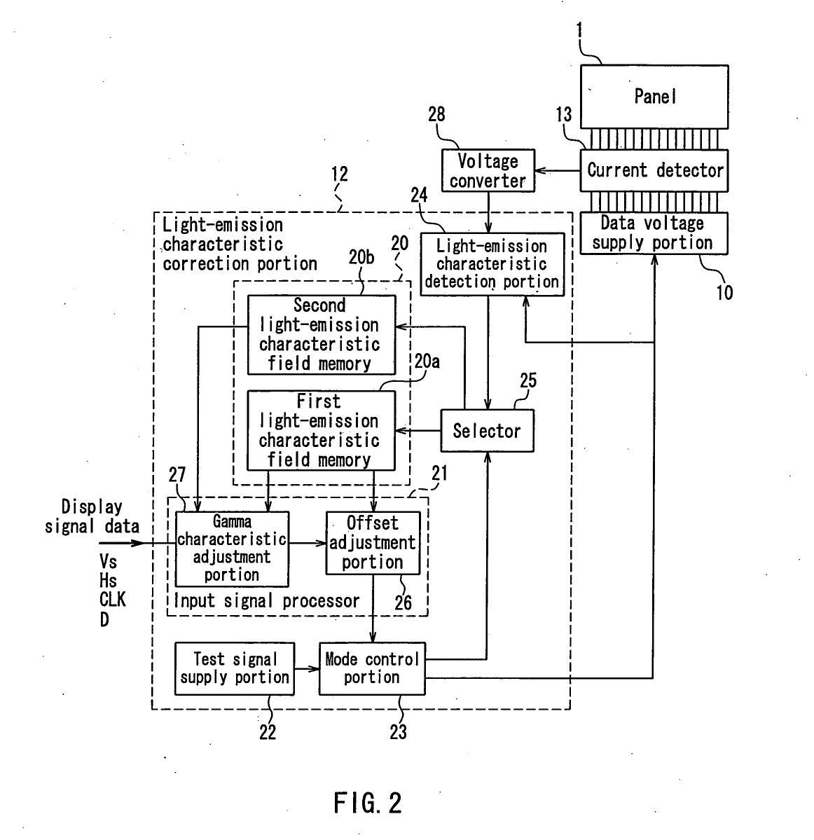

The configuration and operation of the light-emission characteristic correction portion 12 are explained below, referring to the figures. FIG. 2 is a block diagram illustrating the configuration of the light-emission characteristic correction portion 12.

The light-emission characteristic correction portion 12 has a light-emission characteristic memory 20, a display signal processor 21, a test signal supply portion 22, a mode control portion 23, a light-emission characteristic detection portion 24 and a selector 25. The light-emission characteristic memory 20 holds the light-emission characteristic data of each pixel. The display signal processor 21 implements a correction to the display signal data based on the light-emission characteristic supplied from the light-emission characteristic memory 20 and outputs the data. The test signal supply portion 22 generates a test signal so that the test voltage, which is increased from a predetermined low voltage for each pixel, is applied by the data voltage supply portion 10. The mode control portion 23, to which are input the test signals that are the output from the display signal processor 21 and the output from the test signal supply portion 22, selectively outputs one of these to the data voltage supply portion 10. The light-emission characteristic detection portion 24 detects the light-emission characteristic of each pixel, based on the test signal and a light-emission quantity detection value corresponding to the emitted light luminance of each pixel output by the current detector 13. The specific detection method is described below. The selector 25 supplies the detected output from the light-emission characteristic detection portion 24 to the light-emission characteristic memory 20 according to the control of the mode control portion 23.

The mode control portion 23 has a capability for switching between display mode and light-emission characteristic detection mode. When in the display mode, the output from the display signal processor 21, and when in the light-emission characteristic detection mode, the output from the test signal supply portion 22, are each selectively supplied to the data voltage supply portion 10. Furthermore, when in the light-emission characteristic detection mode, the mode control portion 23 controls the selector 25 so as to supply the light-emission characteristic data from the light-emission characteristic detection portion 24 to the light-emission characteristic memory 20.

The light-emission characteristic memory 20 has a first light-emission characteristic field memory 20a for holding first light-emission characteristic data, and a second light-emission characteristic field memory 20b for holding second light-emission characteristic data. The first and the second light-emission characteristic data are described below. Depending on the driving method, a frame memory rather than a field memory may be used.

The display signal processor 21 has an offset adjustment portion 26 and a gamma characteristic adjustment portion 27. The offset adjustment portion 26 implements correction to the display signal data in order to adjust the offset value of the data voltage applied to each pixel, based on the first light-emission characteristic data of each pixel supplied by the first light-emission characteristic field memory 20a. The gamma characteristic adjustment portion 27 detects a gamma characteristic of each pixel based on the first and the second light-emission characteristic data supplied, respectively, by the first and the second light-emission characteristic field memories 20a and 20b, and implements gamma correction on the display signal data, based on the gamma characteristic. The display signal processor 21 applies, to the display signal data, a correction that combines the adjustments from the gamma characteristic adjustment portion 27 and the offset adjustment portion 26 and outputs the data.

The light-emission quantity detection value, being the output from the current detector 13 transformed into voltage by a voltage converter 28, is input to the light-emission characteristic detection portion 24. Additionally, the test signal from the test signal supply portion 22 is supplied, via the mode control portion 23, to the light-emission characteristic detection portion 24. The light-emission characteristic detection portion 24 detects the light-emission characteristic of each pixel, as described below, based on the light-emission quantity detection value and the test signal.

The light-emission characteristic detection mode includes a sequentially executed first detection mode and a second detection mode, in order to supply each output from the test signal supply portion 22 to the data voltage supply portion 10 and to detect the light-emission characteristic of each pixel. That is, in the first and the second detection mode, a test voltage, which is increased from a predetermined low voltage, is applied from the data voltage supply portion 10 to each pixel based on a test signal supplied from the test signal supply portion 22. Thus, each pixel begins to emit light when the test voltage exceeds a threshold voltage, and the emitted light luminance becomes higher according to the voltage-luminance characteristic, as the test voltage increases.

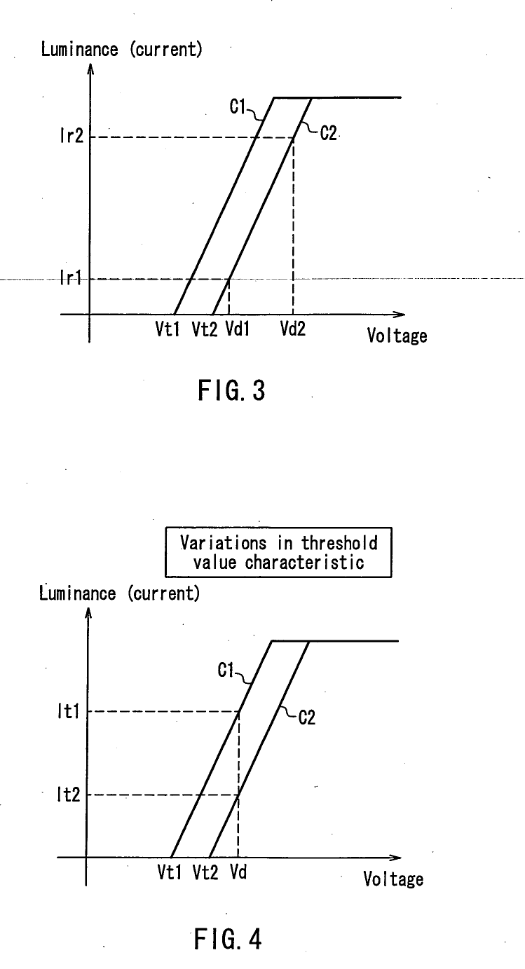

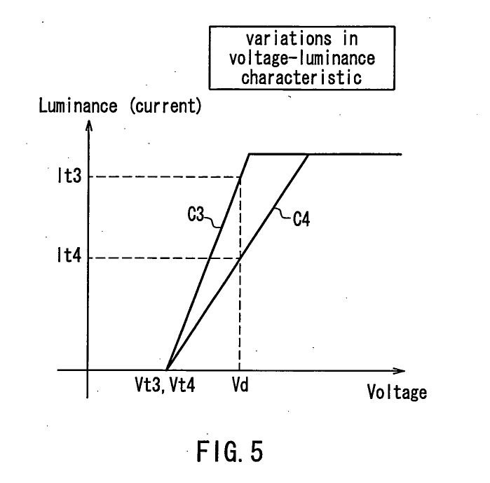

The following explain the operation for detecting the light-emission characteristics in the light-emission characteristic correction portion 12, with reference to FIG. 3. FIG. 3 shows a characteristics of a light-emitting display device similar to that shown in FIG.4.

In the first detection mode, the light-emission characteristic detection portion 24 outputs, as first light-emission characteristic data, the value of a test signal for each pixel when the light-emission quantity detection value output from the voltage converter 28 reaches a first reference value. The value of the test signal corresponds to the data voltage applied to the light-emission element. Therefore, the first reference value corresponds to a luminance Ir1 shown in FIG. 3 and the first light-emission characteristic data corresponds to the data voltage Vd1.

The first reference value is determined so as to have a predetermined relationship with a threshold value for the light-emission element of each pixel. For example, the data voltage Vd applied to the light-emission element, at which light emission has begun and a predetermined luminance is obtained, may be determined as the first reference value corresponding to the threshold. The reason for using such predetermined luminance as the reference is that it is easier to detect the data voltage when the predetermined luminance has been obtained than to detect the data voltage at the start of the light emission. Thus, if the detection is done easily, the first reference value may be determined so as to correspond accurately to the threshold voltage.

Further, in the second detection mode, the light-emission characteristic detection portion 24 outputs, as second light-emission characteristic data, the value of a test signal for each pixel when the light-emission quantity detection value output from the voltage converter 28 reaches a second reference value. The second reference value is set at a voltage higher than the first reference value. The second reference value corresponds to a luminance Ir2 shown in FIG. 3 and the second light-emission characteristic data corresponds to the data voltage Vd2.

The selector 25 is controlled so that in the first detection mode the first light-emission characteristic data is supplied to the first light-emission characteristic field memory 20a, and in the second detection mode the second light-emission characteristic data is supplied to the second light-emission characteristic field memory 20b.

The gamma characteristic adjustment portion 27 detects the gamma characteristic of each pixel based on the first and the second light-emission characteristic data supplied, respectively, by the first and the second light-emission characteristic field memories 20a and 20b, that is, based on the relationship of the applied voltage corresponding to the different emitted light luminances for each pixel. In other words, since the first and the second light-emission characteristic data correspond to the voltage applied to the light-emission elements when the emitted light luminance of each reference value is obtained, the gradient of the voltage-luminance characteristic can be obtained by dividing the difference between the first reference value and the second reference value by the difference between the first and the second light-emission characteristic data. In FIG. 3, as mentioned above, the first and second reference values correspond to luminances Ir1 and Ir2, respectively and the first and second light-emission characteristic data correspond to the data voltages Vd1 and Vd2, respectively. Therefore, the gamma characteristic γ is obtained by the following formula.
γ=(Ir2−Ir1)/(Vd2−Vd1)

The above light-emission characteristic detection modes are, for example, performed when the display device is started up, and correction of the display signal data in subsequent display modes is carried out, based on the light-emission characteristics held in the first and the second light-emission characteristic field memories 20a and 20b.

The light-emission characteristic correction portion 12 is configured as a general IC or as a program using a FPGA or ASIC. For the display signal data, an RGB digital signal (for example, 8 bit serial data) or a component signal [Y, Pb, Pr] (for example, 8 bit serial data) may be used. These signals can also be used as parallel data.

The first and the second light-emission characteristic field memories 20a and 20b can be converted into a ROM, with only the light-emission characteristic data at adjustment in the factory written to the ROM, and the ROM data subsequently can be used as fixed values for the light-emission characteristics. According to this embodiment, the light-emission characteristics can be detected each time the display device is started up, and the data of the first and the second light-emission characteristic field memories 20a and 20b can be updated.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A light-emitting display device comprising a display panel provided with a plurality of arrayed pixels having light-emitting elements, and a driving circuit for supplying data voltage corresponding to display signal data to each of the plurality of pixels, the driving circuit comprising:
a light-emission characteristic correction portion that is supplied with the display signal data from an external source and outputs a signal obtained by subjecting the display signal data to a correction based on a light-emission characteristic of each of the pixels;
a data voltage supply portion that supplies the data voltage for each of the pixels, based on signal output from the light-emission characteristic correction portion; and
a light-emission quantity detector that outputs a light-emission quantity detection value corresponding to light-emission luminance of each of the pixels;
wherein the light-emission characteristic correction portion comprises:
a light-emission characteristic memory holding the light-emission characteristic of each of the pixels;
a display signal processor that subjects the display signal data to a correction based on the light-emission characteristic supplied from the light-emission characteristic memory and outputting the resultant display signal data;
a test signal supply portion for generating a test signal with which a test voltage that increases from a predetermined low voltage is applied from the data voltage supply portion to each of the pixels;
a mode control portion to which the test signal and the output signal from the display signal processor are input, and which selectively outputs one of the signals to the data voltage supply portion;
a light-emission characteristic detection portion that detects the light-emission characteristic of each of the pixels based on the light-emission quantity detection value and the test signal; and
a selector for supplying, according to control by the mode control portion, detected output from the light-emission characteristic detection portion to the light-emission characteristic memory;
the mode control portion having a function of switching between display mode and light-emission characteristic detection mode, supplying output from the display signal processor to the data voltage supply portion when in the display mode, supplying the test signal to the data voltage supply portion when in the light-emission characteristic detection mode, and controlling the selector so as to supply detected output from the light-emission characteristic detection portion to the light-emission characteristic memory.

2. The light-emitting display device according to claim 1, wherein
the light-emission characteristic memory has a first memory for holding first light-emission characteristic data,
the display signal processor has an offset adjustment portion that subjects the display signal data to a correction, based on the first light-emission characteristic data of each of the pixels supplied from the first memory, so as to adjust an offset value of the data voltage applied to each of the pixels; and
the light-emission characteristic detection portion outputs, as the first light-emission characteristic data, the test signal value for each of the pixels at which the output value of the light-emission quantity detector reaches, in the light-emission characteristic detection mode, a first reference value set to have a predetermined relationship with a threshold value of the light-emitting elements.

3. The light-emitting display device according to claim 2, wherein
the light-emission characteristic memory further comprises a second memory for holding second light-emission characteristic data;
the display signal processor further comprises a gamma characteristic adjustment portion that subjects the display signal data to a correction so as to adjust a gamma characteristic of each of the pixels, so that the display signal data is subjected to a composite adjustment by the gamma characteristic adjustment portion and the offset adjustment portion;
the light-emission characteristic detection mode includes a first detection mode and a second detection mode in order to supply the test signal to the data voltage supply portion and to detect the light-emission characteristic;
the light-emission characteristic detection portion, in the first detection mode outputs the first light-emission characteristic data, and in the second detection mode outputs, as the second light-emission characteristic data, the test signal value for each of the pixels at which the output value of the light-emission quantity detector reaches a second reference value;
the selector, in the first detection mode, is controlled to supply the first light-emission characteristic data to the first memory, and in the second detection mode, to supply the second light-emission characteristic data to the second memory; and
the gamma characteristic adjustment portion subjects the display signal data to a correction based on the voltage-luminance characteristic of each of the pixels, the voltage-luminance characteristic being detected based on the first and the second light-emission characteristic data supplied by the first and the second memory, respectively.

4. The light-emitting display device according to claim 1, wherein
the light-emission quantity detector comprises a current detector for detecting current flowing in each of the pixels as a result of the data voltage.

5. The light-emitting display device according to claim 1, wherein the display panel is an inorganic EL display panel and comprises:
a plurality of scanning electrodes;
a plurality of data electrodes intersecting the scanning electrodes;
an inorganic EL light-emission layer, including a dielectric layer and a phosphor layer, disposed between the scanning electrodes and the data electrodes;
a scanning-side driving circuit for sequentially supplying scanning voltage to each of the scanning electrodes;
a data-side driving circuit for supplying data voltage to each of the data electrodes, according to the display signal data; and
a driving control circuit for controlling the scanning-side driving circuit and the data-side driving circuit according to an input signal from an external source; wherein:
the pixels are formed of the inorganic EL light-emission layer positioned at each intersection of the scanning electrodes and the data electrodes;
the data-side driving circuit includes the light-emission characteristic correction portion and the data voltage supply portion; and
the display signal data is supplied to the light-emission characteristic correction portion from the driving control circuit.
